(19) United States
(12) Patent Application Publication
(10) Pub. No.: US 2005/0289626 A1
(43) Pub. Date: Dec. 29, 2005

(54) IP based interactive multimedia communication system

(76) Inventors: Abulgasem Hassan Aboulgasem, Santa Clara, CA (US); Nadeemul Haq, San Jose, CA (US)

Correspondence Address: DAVID GIGLIO, ESQ., 231 ELIZABETH STREET, UTICA, NY, 13501, US

(21) Appl. No.: 10/874,656

(22) Filed: Jun. 23, 2004

(51) Int. Cl. H04N 7/173

(52) U.S. Cl. 725/106; 725/111; 725/122

(57) ABSTRACT

A multimedia communication system provides two way calling between a source and a destination. The source and the destination each include a base station having a call setup and control capability. A media terminal having video/audio compression/decompression capability, video and sound capture capability and multiplexing and transmitting capability is integrated between a television set and the base station. A set-top box connected to a modem allows two way communications between the source and the destination.

This patent application claims priority from provisional patent application 60/481,014 filed on Jun. 23, 2003 by the same inventors which is incorporated herein by reference.

A portion of the disclosure of this patent document contains material to which to claim of copyright protection is made. The copyright owner has no objection to the facsimile reproduction by any person of the patent document or the patent disclosure, as it appears in the U.S. Patent and Trademark Office patent file or records, but reserves all other rights whatsoever.

### FIELD OF THE INVENTION

The present invention relates generally to interactive multi-media communications an more particularly, to a system, which is an integral part of a set-top box or a digital TV or as a stand-alone appliance facilitates video-telephone function, interactive gamine, e-commerce, remote surveillance and on demand content display.

### BACKGROUND OF THE INVENTION

Interactive multi-media communication systems which employ custom audio and video processing components and proprietary signal processing techniques for effectuating multi-media communications over dedicated network links are known. Custom prior art multi-media communication systems can broadly be classified as:
(1) Appliance based
(2) Desk-top based
(3) PC hosted

Both appliance based multi-media communication systems such as the one illustrated in FIG. 1, and desk-top based multi-media communication systems such as the one illustrated in FIG. 2, typically employ a local video processing system 10 and a remote video processing system 20 that exchange audio and video information over a dedicated or specialized network link 30. These systems generally use Integrated Services Digital Network (ISDN) link, employ ITU H.225 protocol for call signaling at ITU H.245 protocol for call control.

The ISDN based systems have the following limitations:
(1) They require more computation and typically longer time to establish call connection
(2) The transport bandwidth provisioning has scaling limitations; scaling can only be performed in multiples of B-channel bandwidth.
(3) They expect constant bit-rate traffic and do not perform well when variable bit-rate traffic is presented, for example traffic over public Internet when no sustained bandwidth guarantees are available.
(4) They require ISDN sockets that are provisioned by the local service provider.
(5) Equipment is confined to the locale where the ISDN socket is available.
(6) ISDN calls are significantly more expensive than regular telephone calls.
(7) ISDN call connections access carrier domains are not robust.

The coders/decoders used in appliance and desktop based video conferencing equipment for compression of natural video are based on ITU standards H.261 and H.263. These standards use block Discrete Cosine Transform (DCT) and motion estimation to achieve compression. The block Discrete Cosine Transform based compression has the following limitations:
(1) The compression ratio is not enough to allow use of low bandwidth access media such as cable modem and some DSL modems for high quality video.
(2) Block Discrete Cosine Transform (DCT) occasionally results in artifacts on block boundaries.

The PC hosted multi-media communication systems are illustrated in FIG. 3, comprise a local PC with a video capture cared and a sound card installed on the PC expansion slots and attached to external camera and microphones respectively and remote PC with a similar setup. PC hosted video conferencing systems have the following limitations:
(1) There is no built-in mechanism for alerting the called party; and instant messenger or a telephone call is required to alert the called party. Instant messaging has its own limitations.
(2) Only computer savvy users can benefit from PC hosted multi-media communication.
(3) Use of soft coders/decoders because of their high compute requirements limit the displayable video resolution.
(4) While the PC is used for video conferencing the PC compute capability is shared with other tasks in process on the PC.

### SUMMARY AND OBJECTS OF THE PRESENT INVENTION

It is an object of the present invention to improve the art of transporting multimedia communication data.

It is another object of the present invention to minimize the complexity of installing and configuring multi-media communication systems.

It is yet another object of the present invention to make multimedia systems easier to use.

It is still another object of the present invention to improve the art of the telephone.

It is a further object of the present invention to provide improved quality of video resolution with full-color, full-motion and high fidelity audio over available bandwidth.

It is yet a further object of the present invention to provide lower cost consumer multimedia equipment.

It is still yet another object of the present invention to provide call oriented multi-media sessions to enable billing by the provider per usage.

It is yet still a further object of the present invention to communicate over multimedia systems in conformity with internationally recognized communication standards.

These and other objects and features of the present invention are provided by a multimedia communication system having two way calling capability between a source and a destination. The source and the destination each include a base station having a call setup and control capability. A media terminal having video/audio compression/decompression capability, video and sound capture capability and multiplexing and transmitting capability is integrated between a television set and the base station. A set-top box connected to a modem allows two way communications between the source and the destination.

### BRIEF DESCRIPTION OF THE DRAWINGS

The above and other objects of the present invention will be better understood by reading the following detailed description of the preferred embodiments of the invention, when considered in connection with the accompanying drawings, in which:

FIG. 1 is a block diagram of an appliance based multi-media communication system;

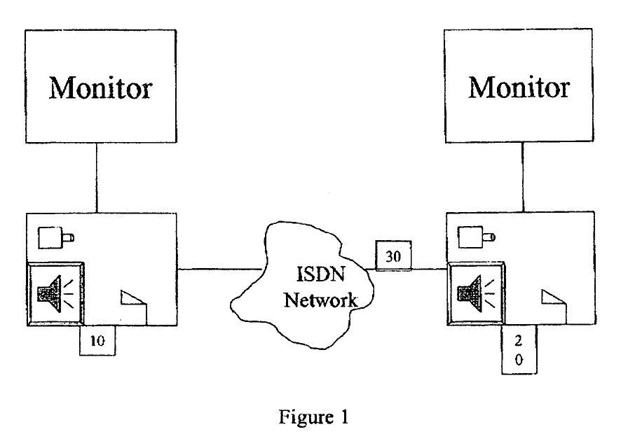

FIG. 2 is a block diagram of a desk-top based multi-media communication system;

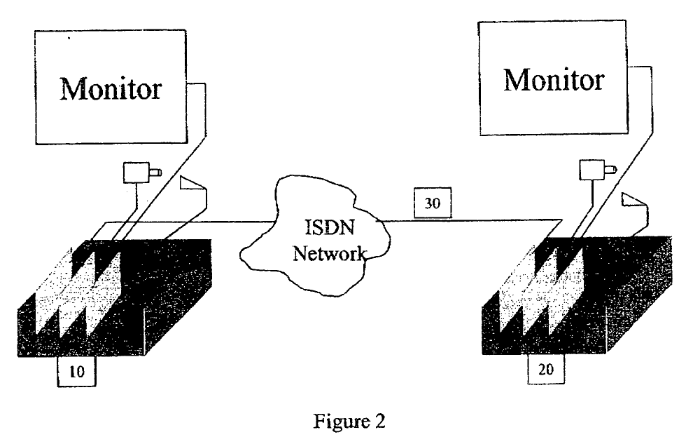

FIG. 3 is a block diagram of a PC hosted multi-media communication system in accordance with the present invention;

FIG. 4 is a block diagram of a system in accordance with the present invention wherein a Cable MODEM provides the communication channel over internet to the other party. Normally TV signals from the Cable are routed by the system to the TV set, in the event of a video-call video and audio from the other party are multiplexed to the TV set. A micro-phone and video-camera built into the system carry processed audio and video signal to the other party;

FIG. 5 is a block diagram of an alternative embodiment of the system shown in FIG. 4 wherein a set-top and cable MODEM are housed in the same enclosure;

FIG. 6 is a block diagram of yet another embodiment of the system of FIG. 4 wherein a TV set has the set-top box incorporated in the same enclosure;

FIG. 7 is a block diagram of still another embodiment of the system of FIG. 4 the set-top box the cable MODEM and the system are housed in the same enclosure;

FIG. 8 is a block diagram of still a further embodiment of the system of FIG. 4; wherein the set-top box the cable MODEM and the TV set are housed in the same enclosure.

FIG. 9 is a block diagram of yet still another embodiment of the system of FIG. 4 wherein the TV set, Cable MODEM, set-top box and the proposed system are housed in the same enclosure;

FIG. 10 is a block diagram of an embodiment of the present invention wherein a wireless link (802.11 a/b/g) between the system and a DSL router provides the communication channel over internet for the video call; and

FIG. 14 is a block diagram of an embodiment of the system wherein the communication channel over internet is provided by a wide-band RF MODEM. The TV set is used as the display device.

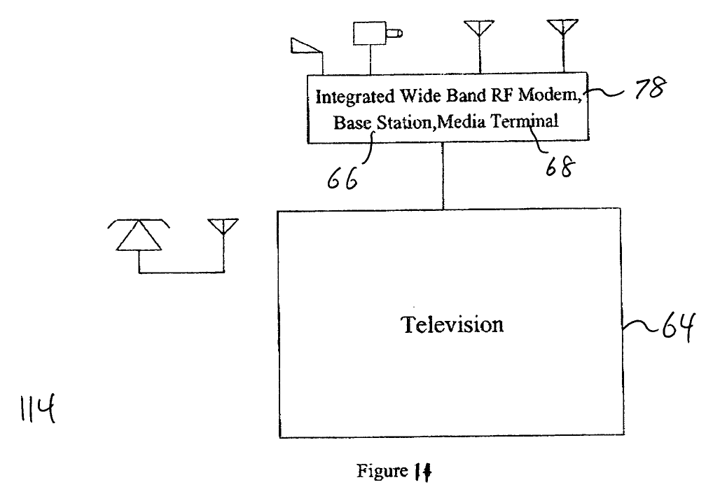

### DETAILED DESCRIPTION OF THE PRESENT INVENTION

Great improvements have been made on the Internet backbone and access technology since the introduction of state of the art multi-media communication systems.

IETF-rfc 253 the Session Initiation Protocol is now an approved standard for call signaling over Internet. It is a lightweight signaling protocol and is widely used for VoIP call signaling.

IETF-rfc 2916 is targeted on convergence of public switched telephone network (PSTN) and the IP network; it is the mapping of a telephone number from the PSTN to Internet services (telephone number in, URI out). ENUM assists in locating services on the internet using only a telephone number. Using ENUM, telephones, which have an input mechanism limited to 12 keys on a keypad, are be used to access internet services.

High bandwidth access to consumer in the past was available only through frac-T1, frac-E1 and through ISDN lines; recent advances in technology have resulted in widespread deployment of Data over Cable interface Specification (DOCSIS) Modems and Digital Subscriber Loop (DSL) Modems. Work is in progress on wideband wireless access. These new access technologies now guarantee a minimum bandwidth in both upstream and downstream directions.

Traffic congestion in the Internet backbone is mitigated by use of recent advances in provisioning of Quality of Service (QoS) using packet marking and Multi-protocol Label Switching.

Bandwidth reservation protocols such as RSVP help in mitigating the effects of congestion on the backbone routers.

Advances in compression technology now allow better audio/video quality within available bandwidth. Some algorithms support layered video compression; this allows dynamic (video quality) scaling over variable bandwidth.

Better error resilience in error prone environment at low bit-rates is another key feature of the internationally recognized moving picture standards such as MPEG-4, which contributes to better call quality.

Even though some of the above described systems can be used in accordance with the embodiments of the present invention, there are more efficient methods to achieve appropriate multimedia data transport at a desirable rate.

For two-way video transport a method has been provided in a co-pending application filed on Jun. 21, 2004 by the same inventors, which claims priority from provisional patent application 60/481,004 filed on Jun. 20, 2003, which is hereby incorporated by reference. The method is intended for two-way communication therefore at-least two sources and two destinations are involved; however, since the setup is similar at both ends, description of method from a source to a destination would suffice.

The method assumes use of similar or compatible equipment at both source and destination.

Since packet delays and delay variation through the network are not known and cannot be predicted accurately at the source, the algorithm is largely implemented at the destination.

Because of round-trip delay constraint on two-way communication, algorithms based on closed loop feedback are not viable.

At the Source, raw picture frames are received from the camera. Raw picture frames (RGB) are Gamma corrected and quantized/compressed to generate quantized frames.

A quantized/compressed frame (I-frame) is segmented into multiple sub-frames. The sub-frames are packetized. The maximum size of sub-frames is determined by the available bit rate such that transmission of a complete sub-frame packet is possible over the network during Tf. ‘Tf’ is a measure of time that is based on frequency of audio packets.

The sub-frame comprises:
(1) A sequence number field that is used to:
   (a) Help reconstruct the original I-frame at the destination
   (b) Allow compensation for sub-frame packets that may be lost or delayed excessively in the network
(2) Corresponding I-frame segment

Motion vectors and associated errors are generated for all subsequent quantized frames received from the camera until all sub-frame packets of the first I-frame have been transmitted.

The motion vectors are packetized.

A motion vector packet is transmitted (every Tf) between successive sub-frame packets. The motion vector packets therefore effectively cut through sub-frames of the first I-frame completely transmitted.

Once all sub-frames of the first I-frame have been transmitted another I-frame is segmented into sub-frames. The sub-frames are packetized and transmission cycle is repeated.

At the destination, there is provided a dual display buffer Dbuf0 and Dbuf1, dual I-frame buffers Ibuf0 and Ibuf1, a motion vectors buffer and a backup display buffer.

Since each sub-frame is a fixed size the location of the sub-frame within the I-frame buffer is known. As sub-frames of the first I-frame are received they are stored in Ibuf1 in their corresponding location.

As motion vectors and associated prediction errors are received they are stored in the motion vector buffer.

A timer triggers update of the display buffer Dbuf0 every Tf period and the next available motion vector and associated prediction errors are applied to it.

This process continues till all sub-frames of the first I-frame have been received in Ibuf1.

At this time contents of the Ibuf1 are inverse-coded into Dbuf1 and motion vectors stored in the motion vector buffer and their associated prediction errors are applied sequentially to I-frame stored in Ibuf1.

A copy of Dbuf1 is saved in the backup display buffer. Contents of the backup display buffer when coded are used to substitute missing or corrupted sub-frames of the incoming I-frame.

After all motion vectors stored in the motion vector buffer have been applied to the contents of Ibuf1 the following happens:
(a) Dbuf1 becomes the current display buffer
(b) Motion vector buffer is flushed

As sub-frames of the second I-frame are received they are stored in Ibuf0 in their corresponding location.

As motion vectors and associated prediction errors are received they are stored in the motion vector buffer.

A timer triggers update of the display buffer Dbuf1 every Tf period and the next available motion vector and associated prediction errors are applied to it.

This process continues till all sub-frames of the second I-frame have been received in Ibuf0.

Contents of Ibuf0 are inverse-coded into Dbuf0 and motion vectors stored in the motion vector buffer and their associated prediction errors are applied sequentially to I-frame stored in Ibuf0.

A copy of Dbuf0 is saved in the backup display buffer. Contents of the backup display buffer when coded are used to substitute missing or corrupted sub-frames of the incoming I-frame.

After all motion vectors stored in the motion vector buffer have been applied to the contents of Ibuf0 the following happens:
(a) Dbuf0 becomes the current display buffer
(b) Motion vector buffer is flushed
(c) Sub-frames of the next I-frame are stored in Ibuf1.

This process keeps repeating itself.

A second method of video transport has been provided in a second co-pending application filed on Jun. 22, 2004 by the same inventors, which claims priority from provisional patent application 60/481,008 filed on Jun. 22, 2003, which is hereby incorporated by reference. In this second method, temporal and spatial redundancy in natural video frame sequences is exploited to achieve high degree of compression for optimal use of available bandwidth.

A transmitted video sequence is encoded as a series of packetized reference frames interspersed with motion vectors and associated error packets at the source.

At the destination, reference frames are recovered after decode and inverse transform of received reference frame packets.

Received motion vectors and associated error corrections are applied to the reference frame to generate P-frames. The P-frames are displayed until the next I-frame is received. This cycle is repeated continuously.

Spatial transform packets also known as I-frame packets are generated using two-dimensional wavelet transform and SPIHT coding.

Set partitioning in hierarchical trees (SPIHT) coding introduced by Amir Said and William Pearlman is an effective technique that is used to accomplish embedded coding. The SPIHT algorithm uses the principle of partial ordering by magnitude. It is therefore possible to truncate the transmitted code to match the available bit rate with optimal use of the available bandwidth.

Temporal Redundancy to Compensate for Spatial Corruption

The significant difficulty with embedded coding however is that even a single bit error in transmission could cause the decoder to completely loose track of the code. This makes SPIHT a bad candidate for noisy networks.

One property of the SPIHT coded image is that where a highly localized filter is used to transform the image, a 2×2 block of the SPIHT root are the roots of trees that represent a well defined part of the whole image. For example, when a common intermediate format “CIF” size image (352×288) is transformed and coded, a 2×2 block of the roots represent a 32×32 pixel portion of the whole image.

This very important property is utilized in this invention. The image is broken up into 2×2 blocks at the root. Each block's trees are separately encapsulated in packets. For example a CIF image is subdivided into 99 blocks and encapsulated in separate packets. The effect of a packet loss or corruption is thus localized (isolated). The corrupted packets are dropped, thus no bandwidth is spent on redundancy for forward error correction.

The destination always keeps a copy of the previous I-frame that is updated by motion vectors and associated error corrections for subsequent frames. Utilizing property of natural video, of continuity in scenes, the portion of the image that was lost or corrupted is updated from its copy of previous updated I-frame. Thus temporal redundancy is used to compensate for partial loss of spatial packets.

Mitigating Loss or Corruption of Temporal Information

The image is subdivided into virtual blocks (16×16). Motion vectors and associated errors are generated.

At the source the generated motion vectors and errors are encapsulated in a multiplicity of packets to minimize the impact of corruption.

The packet header contains information regarding the part of image that the packet is applicable to.

The packet consists of the map of a portion of the image whose motion vectors and associated errors are also encapsulated in the packet. Each bit in the map represents a virtual block that is part of the image. A one bit in the bit position on the map indicates presence of motion vector and or error for the corresponding virtual block. A zero indicates no motion vector or error. The rest of the packet is packed with motion vectors and errors of fixed length that occur in the same sequence as the bit map is traversed.

Since a bit error on the map could cause motion vectors and or errors to be applied incorrectly the bit map is protected (with cyclical redundancy checking).

If an error is detected in the bit map of a packet the whole packet is dropped and the sequentially previous motion vector are applied for the same part of image. If the bit error occurs in the portion of motion vector or error information the distortion is tolerated.

Thus minimum redundancy is used for error detection.

Since I-frame is transmitted frequently from source to destination, residual cumulative errors or distortion introduced by application of previous motion vectors is short lived.

Compensating for Delayed Temporal Information

Normally motion vector and error packets are expected to arrive at the destination after typical delay, however it is possible that the packets will be excessively delayed in the network due to congestion or routing. If this happens then a copy of the image before application of motion vector or error compensation is stored. The sequentially previous motion vector or error is applied to the current display.

When the delayed packet arrives at the destination the motion vectors and error compensation are applied to the stored copy and then restored as the current image.

Therefore, there is provided an application which uses set partitioning in hierarchical trees (SPIHT) as part of a video Code/Decoder for interactive multimedia communications over a variable bit-rate network. This method does not require forward error correction or re-transmission of corrupted data, which are tedious especially over noisy networks. The application provided by the present invention provides a method of compensation for excessively delayed data packets, without cumulative distortion.

A method of encrypting the video transport that can be used in conjunction with the present invention has been provided in a third co-pending application filed on Jun. 21, 2004 by the same inventors, which claims priority from provisional patent application 60/481,006 filed on Jun. 21, 2003, which is hereby incorporated by reference. For video encryption, wavelet transform for compression, decomposition of the image matrix is achieved by successive applications of a wavelet transform. The wavelet transform is applied to each row of the image of dimension N, first over vector of length N then over the “smooth” vector of length N/2, then over the “smooth-smooth” vector of length N/4 and so on, until only a trivial number of “smooth- . . . -smooth” components (usually 2) remain for each row.

The smooth vector in each instance is obtained by critically sub-sampling the result of application of the transform.

The process is repeated for each column of the image of dimension M until only a trivial number of “smooth- . . . -smooth” (usually 2) components remain for each column.

The final result is a matrix of coefficients of dimensions N×M.

The matrix comprises of a hierarchy of sub-bands. The sub-bands are logarithmically spaced in frequency and represent octave-band decomposition.

The lowest frequency sub-band is a representation of the information at all coarser scales. This sub-band comprises of the “smooth- . . . -smooth” coefficients also known as the “mother-function coefficients” which were obtained in the last iteration of transformation.

The invention proposes to encrypt in a loss-less way one coefficient, the coefficient that does not have any descendents, from each group of roots that comprise the “mother-function coefficient sub-band.” This suffices to encrypt the whole image since inverse transformation to retrieve the original image (the I-frame) requires the “mother-function coefficients” for regeneration

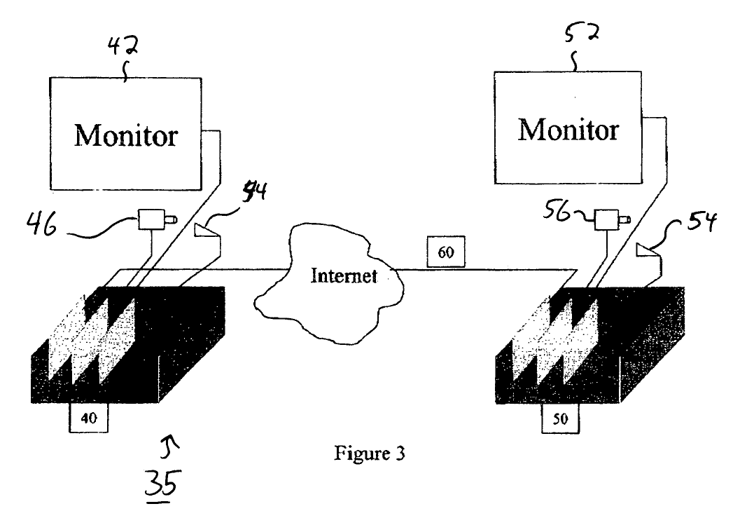

Various embodiments of multimedia communications will now be shown and described. Referring now to FIG. 3 there is shown a personal computer hosted multi-media communication system 35. Multimedia data includes at video and/or audio. A first central processing unit 40 and second processing unit 50 each include processing software for transmitting and receiving multimedia data. Appropriate hardware at each destination includes a monitor 42, 52 for viewing the video portion of the communications. Telephones 44, 54 provide the users with audio capability. A camera 46, 56 and telephones 44, 54 allow the users to transmit audio and video information. The audio and video information is transmitted through known transmission medium 60.

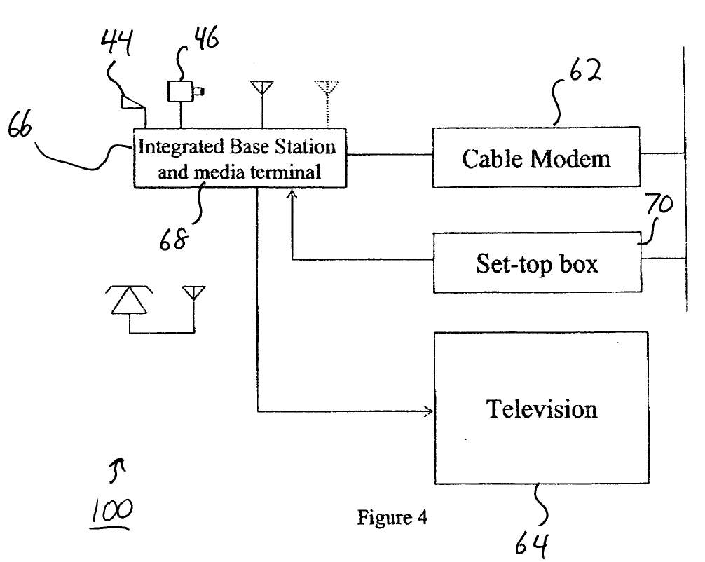

Looking at a system 100 depicted in FIG. 4, a cable 62 modem provides the communication channel over known transmission medium 60, including the internet, to the other party. Normally, television signals from the cable are routed by the system to a television set 64. In the event of a video-call, video and audio information from the calling party are multiplexed to the television set 64. An integrated base station 66 includes an audio input device, such as micro-phone or telephone 44, and a video input device 46, for example a CCD/CMOS picture-camera to originate audio an video information, which is then processed by software inside of a media terminal 68, usually co-located with the base station 66, and then transmitted to the calling party.

Typically the base station 66 provides call setup and control, RTP payload routing to/from the media terminals, peripherals and handset, and acts as an 802.11 home base hub function when the base station 66 and media terminal 68 are not co-located.

The media terminal 68 typically receives encoded/compressed audio/video RTP packets from the base station 66. The media terminal 68 decodes and un-compresses the audio/video frames and renders NTSC/PAL/SECAM compliant analog output signal for the analog television and/or RGB signal for computer monitors and/or S-video compliant signal for DTV and/or HDMI compliant signals for future DTV. The media terminal 68 further captures video frames through a video capture device and captures audio frames through a sound capture device. The media terminal 68 then compresses, encodes and encrypts audio/video frames to RTP packets. Finally, the media terminal 68 multiplexes and transmits the RTP packets to the base station 66.

A telephone handset is used to initiate an audio or video call and also to alert the called party as to an incoming call.

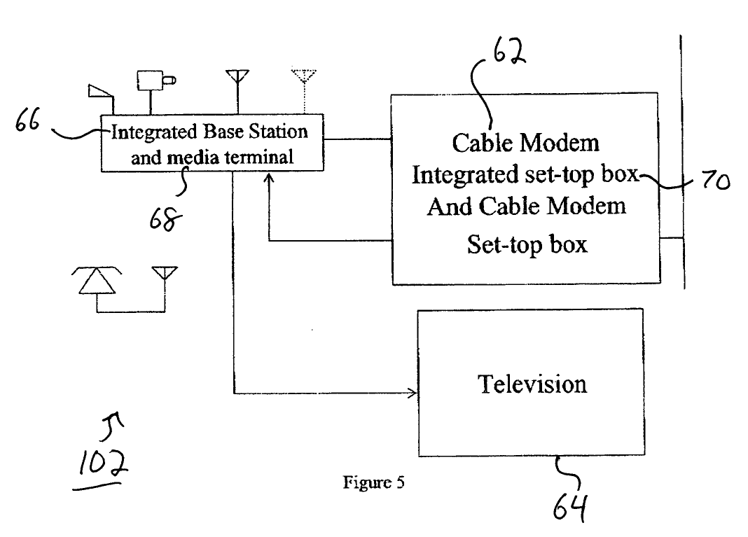

A system 102 shown in FIG. 5 functions the same as the system described in FIG. 4, except an integrated set-top box 70 houses both the cable modem 62 and the set-top box 70.

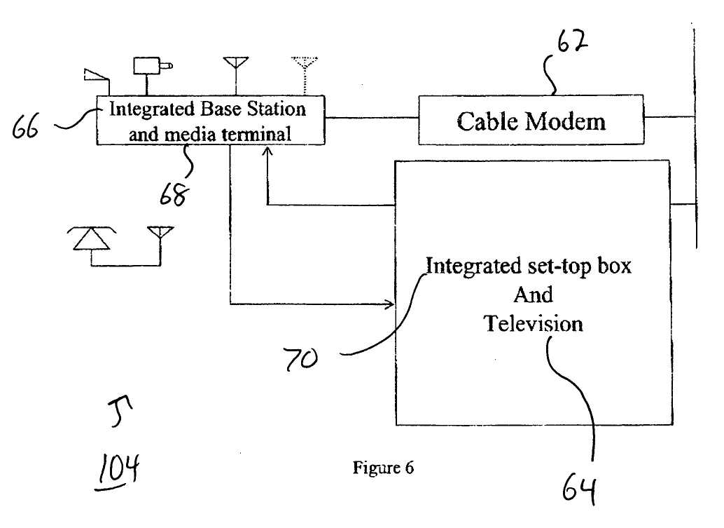

Turning now to FIG. 6, a system 104 includes the television 64 and set-top box 70 in a single housing. The cable modem 62 provides communications capability over known transmission medium, including the internet to a second party (not shown). Video-calls are transmitted through the auxiliary input of the television set. In the embodiment shown in FIG. 6, user intervention is necessary to display audio and video from the second party in the event of a video call.

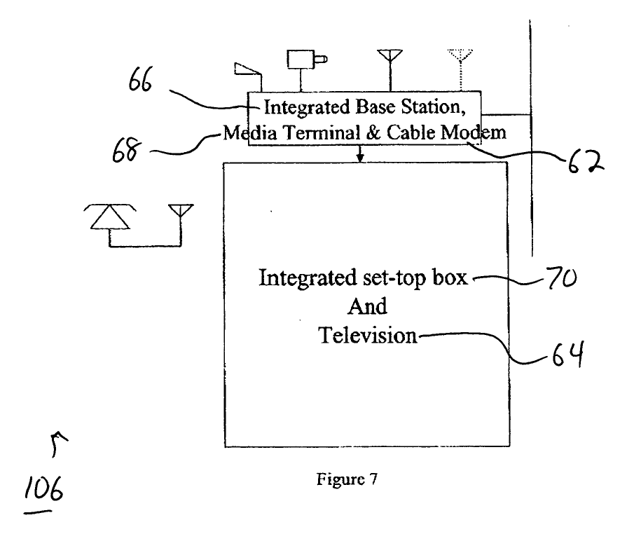

FIG. 7 shows a system 106 that operates similar to the system of FIG. 6, wherein the cable modem 62 and the integrated base station 66 housed in a single housing.

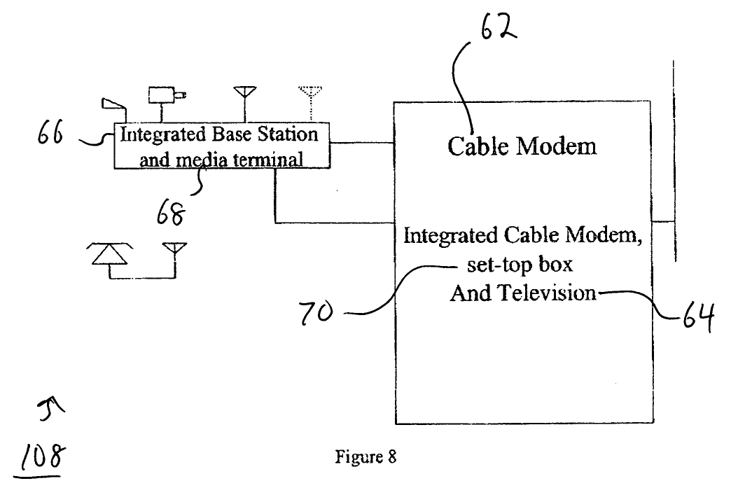

FIG. 8 shows a system 108 wherein a single housing incorporates the cable modem 62, the set-top box 70 and the television set 64. The integrated base station 66 is connected through an auxiliary port of the television set. Once again user intervention is required to display audio and video from the calling party.

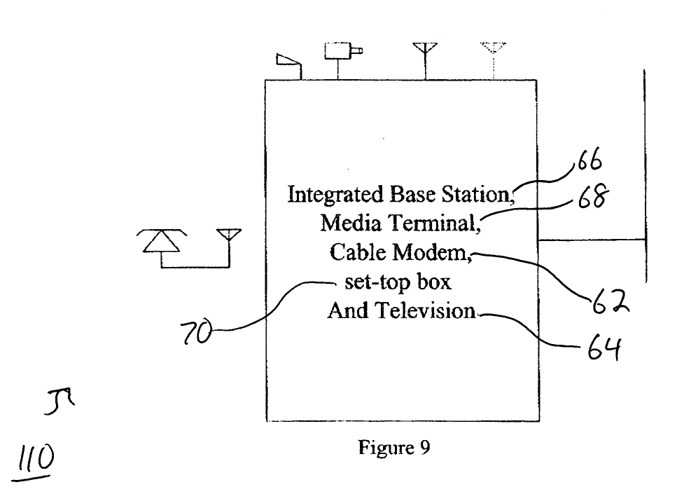

FIG. 9 shows a system 110 wherein a single housing encloses the cable modem 62, the set-top box 70, the television set 64 and the integrated base station 66.

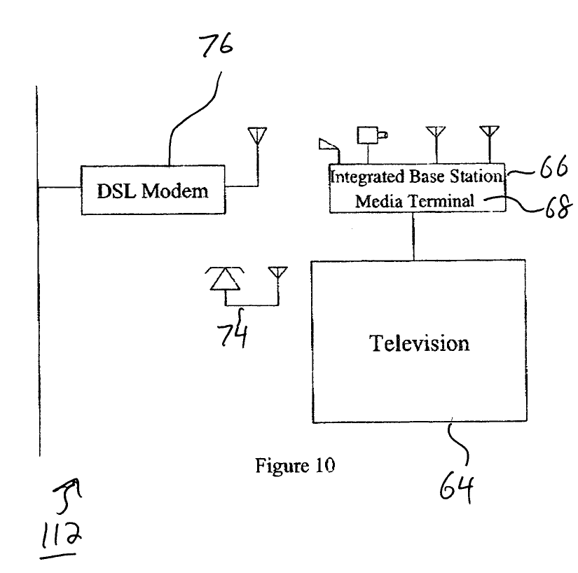

FIG. 10 shows a system 112 which incorporates a wireless link 74 (eg. 802.11 a/b/g) between the system and a DSL Router 76 to provide the communication channel over the internet for the video call. Normally, television signals from the wireless link are routed by the system to the television set. In the event of a video-call, video and audio information from the calling party are multiplexed to the television set. An integrated base station includes a micro-phone and a CCD/CMOS picture-camera to originate audio an video information, which is then processed by software inside of the media terminal and transmitted to the calling party.

Finally, FIG. 11 shows a system 114 which uses a wide band RF modem 78 to provide communications over the internet. Normally, television signals from the RF modem are routed by the system to the television set. In the event of a video-call, video and audio information from the calling party are multiplexed to the television set. An integrated base station includes a micro-phone and a video camera to originate audio an video information, which is then processed by in the media terminal and transmitted to the calling party.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

1. A system for two-way video calling, said system comprising:
a source and a destination, each of said source and destination including:
a base station having a call setup and control capability;
a media terminal having video/audio compression/decompression capability, further including video and sound capture capability, said media terminal further including multiplexing and transmitting capability; and
a television set integrated with a set-top box and connected to a modem, wherein said modem communicates through known communication medium between the source and destination.
